(19) United States
(12) Patent Application Publication
(10) Pub. No.: US 2018/0372906 A1
(43) Pub. Date: Dec. 27, 2018

(54) Determining Downhole Wettability

(71) Applicant: Halliburton Energy Services, Inc., Houston, TX (US)

(72) Inventors: Junsheng Hou, Kingwood, TX (US); Natasa Mekic, Spring, TX (US); Weijun Guo, Houston, TX (US)

(73) Assignee: Halliburton Energy Services, Inc., Houston, TX (US)

(21) Appl. No.: 16/064,270

(22) PCT Filed: Jan. 22, 2016
(86) PCT No.: PCT/US16/14536

§ 371 Date: Jun. 20, 2018

(51) Int. Cl. G01V 3/32; E21B 49/00; G01N 13/00; G01N 24/08; G01V 3/38

(52) U.S. Cl. CPC G01V 3/32; E21B 49/00; G01V 3/38; G01N 24/081; G01N 13/00

(57) ABSTRACT

A system for determining a wettability associated with a subterranean formation can include a dielectric logging tool, a resistivity logging tool, a pulsed neutron tool, and a computing device. The dielectric logging tool can transmit a first data set associated with the subterranean formation. The resistivity logging tool can transmit a second data set associated with the subterranean formation. The pulsed neutron tool can transmit a third data set associated with the subterranean formation. The computing device can be in communication with the dielectric logging tool, the resistivity logging tool, and the pulsed neutron tool. The computing device can receive the first data set, the second data set, and the third data set and determine the wettability associated with the subterranean formation based on the first data set, the second data set, and the third data set.

### TECHNICAL FIELD

The present disclosure relates generally to devices for use in well systems. More specifically, but not by way of limitation, this disclosure relates to determining downhole wettability.

### BACKGROUND

Wettability can be the “preference” of a solid material (e.g., rock grains) to be in contact with one fluid rather than another fluid. The fluid can be a liquid or a gas. For example, a “water-wet” rock can prefer to contact water, such that any water contacting the rock will spread across a surface of the rock or be imbibed by the rock. The water can displace other fluids contacting the rock, such as oil or gas. As another example, an “oil-wet” rock can prefer to contact oil, such that any oil contacting the rock will spread across a surface of the rock or be imbibed by the rock. The oil can displace other fluids contacting the rock, such as water or gas.

The wettability of a solid material can be described along a continuum, with “strongly water-wet” at one end of the continuum and “strongly oil-wet” at the other end of the continuum. If the solid material does not have a discernible preference for one fluid over another, the solid can be described as “intermediate wet” or “neutral wet.”

The wettability of a subterranean formation from which a wellbore is drilled (e.g., for an oil or gas well system) can influence the behavior of the wellbore. For example, the wettability of the subterranean formation can impact important wellbore properties, such as residual oil saturation, relative permeability, and capillary pressure. It can be desirable to determine the wettability of the subterranean formation prior to performing, or during, well operations.

### BRIEF DESCRIPTION OF THE DRAWINGS

FIG. 1 is a cross-sectional view of an example of a well system that includes a system for determining downhole wettability according to some aspects.

FIG. 2 is a cross-sectional view of an example of part of a well system that includes a system for determining downhole wettability according to some aspects.

FIG. 3 is a block diagram of an example of a system for determining downhole wettability according to some aspects.

FIG. 4 is an example of a flow chart of a process for determining downhole wettability according to some aspects.

FIG. 5 is a cross-sectional view of a layer of shale positioned adjacent to a layer of sand in a subterranean formation according to some aspects.

### DETAILED DESCRIPTION

Certain aspects and features of the present disclosure relate to determining downhole wettability of a subterranean formation using data from a dielectric logging tool, a resistivity logging tool, a pulsed-neutron tool, or any combination of these. Determining the wettability of the subterranean formation based on data from a dielectric logging tool, a resistivity logging tool, or a pulsed-neutron tool can be more accurate, cheaper, easier, and faster than determining wettability using other methods. For example, determining wettability by analyzing core samples taken from the subterranean formation can be tedious, time-consuming, and expensive. Further, some examples can avoid the costs and practical difficulties associated with operating nuclear-magnetic-resonance tools.

In some examples, wettability can be determined using the data from the dielectric logging tool, resistivity logging tool, and pulsed-neutron tool using relationships that correct for various downhole conditions. For example, wettability can be determined using relationships that correct for the presence of clay, pyrite, boron, lamination(s), or any combination of these in the subterranean formation. This can lead to a more accurate determination of wettability.

In some examples, a database can be constructed that includes the determined wettability correlated to other information associated with the subterranean formation. For example, a computing device can receive information about fluids produced from a wellbore formed in the subterranean formation, such as hydrocarbon-production characteristics. For example, the computing device can receive the information from a well operator through an input device, such as a keyboard or mouse. In some examples, the information can include an oil-to-water ratio produced from the wellbore. The computing device can receive the information and construct a database that includes the determined wettability correlated to the information about the fluids produced from the wellbore.

The database can include a lookup table or guide usable for other wellbores with unknown fluid-production characteristics. For example, the computing device can determine another wettability associated with another wellbore (e.g., based on data from another dielectric logging tool, resistivity logging tool, and pulsed-neutron tool). In some examples, the computing device can access the database and determine one or more hydrocarbon-production characteristics associated with the other wellbore based on the other wettability. In some examples, the determined hydrocarbon-production characteristics can help a well operator predict how the other wellbore will perform.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

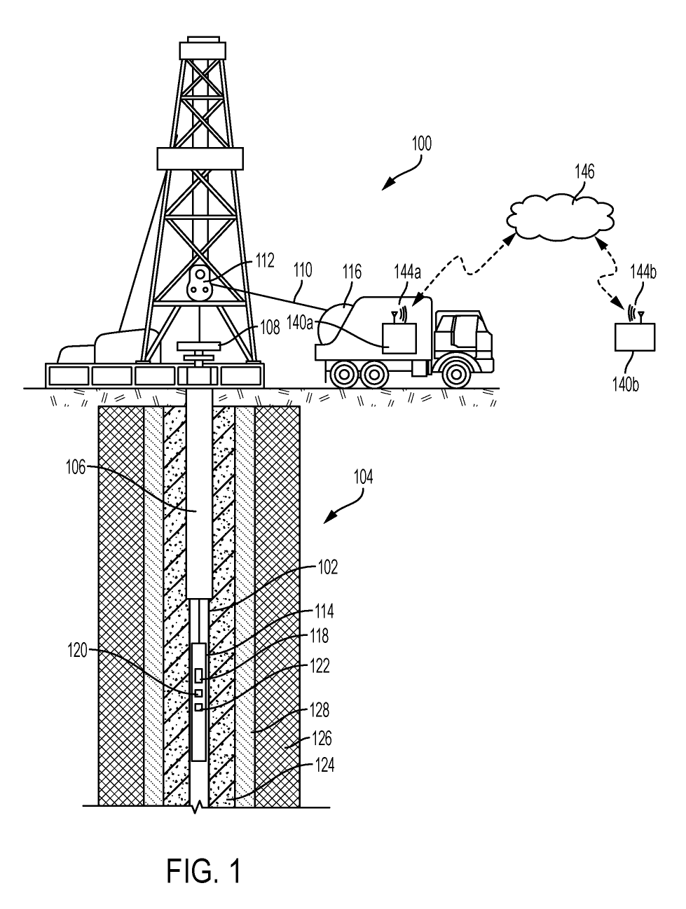

FIG. 1 is a cross-sectional view of an example of a well system 100 for determining downhole wettability according to some aspects. The well system 100 includes a wellbore 102 extending through various earth strata. For example, the wellbore 102 can extend through a hydrocarbon-bearing subterranean formation 104.

The subterranean formation 104 can include an invaded zone 124 (e.g., a “flushed zone”). The invaded zone 124 can include a portion of the subterranean formation 104 that is close to a wall of the wellbore 102 in which hydrocarbons, water, or both have been substantially entirely displaced by a mud filtrate. The mud filtrate can include mud (e.g., circulated through the wellbore 102 during drilling operations) that has filtered into pores of the rock or other material forming the subterranean formation 104. In some examples, the subterranean formation 104 can include an uninvaded zone 126. The uninvaded zone 126 can include portion of the subterranean formation 104 that has not been penetrated by the mud filtrate (e.g., the opposite of the invaded zone 124). In some examples, the subterranean formation 104 can include a transition zone 128. The transition zone 128 can include a portion of the subterranean formation 104 between the invaded zone 124 and the uninvaded zone 126 that is partially penetrated by the mud filtrate.

The wellbore 102 can be cased or open-hole. For example, a casing string 106 can extend from a well surface 108 to the subterranean formation 104. The casing string 106 can provide a conduit through which formation fluids, such as production fluids produced from the subterranean formation 104, can travel from the wellbore 102 to the well surface 108. The casing string 106 can be coupled to the walls of the wellbore 102 via cement. For example, a cement sheath can be positioned or formed between the casing string 106 and the walls of the wellbore 102 for coupling the casing string 106 to the wellbore 102. The wellbore 102 can be vertical, deviated, horizontal, or any combination of these.

The well system 100 can include at least one well tool 114 (e.g., a formation-testing tool). The well tool 114 can be coupled to a wireline 110, slickline, or coiled tube that can be deployed into the wellbore 102. The wireline 110, slickline, or coiled tube can be guided into the wellbore 102 using, for example, a guide 112 or winch. In some examples, the wireline 110, slickline, or coiled tube can be wound around a reel 116.

In some examples, the well tool 114 can include a dielectric logging tool 118. One example of the dielectric logging tool can include the Halliburton™ HFDT™ (High-Frequency Dielectric Tool). The dielectric logging tool 118 can detect a dielectric constant of the subterranean formation 104. In some examples, the dielectric logging tool 118 can detect a porosity, a saturation, or both associated with the invaded zone 124. In some examples, the porosity, saturation, or both can be usable to determine a wettability associated with the subterranean formation 104.

In some examples, the well tool 114 can include a resistivity logging tool 120. One example of the resistivity logging tool 120 can include the Halliburton™ Xaminer™—MCI (Multicomponent Induction) tool. The resistivity logging tool 120 can measure a resistivity associated with the subterranean formation 104. In some examples, the resistivity logging tool 120 can be used measure resistivities of the subterranean formation 104 vertically, horizontally, or both (e.g., at different depths in the wellbore 102). In some examples, one or more of the resistivities can be usable to determine the wettability associated with the subterranean formation 104.

In some examples, the well tool 114 can include a pulsed-neutron tool 122. One example of the pulsed-neutron tool 122 can include the Halliburton™ TMD3D™ (Thermal Multigate Decay—3 Detector). The pulsed-neutron tool 122 can detect a porosity of the subterranean formation 104. In some examples, the pulsed-neutron tool 122 can detect a saturation associated with the invaded zone 124, the uninvaded zone 126, or both in the wellbore 102. In some examples, the porosity, the saturation in one or more invaded zones 124, the saturation in one or more uninvaded zones 126, or any combination of these can be usable to determine the wettability associated with the subterranean formation 104.

The dielectric logging tool 118, resistivity logging tool 120, and pulsed-neutron tool 122 can be deployed in the wellbore 102 using any number and combination of well tools 114. In one example, the dielectric logging tool 118 and the resistivity logging tool 120 can be implemented as part of a drill string for drilling the wellbore 102. The dielectric logging tool 118 and the resistivity logging tool 120 can be operated during drilling operations to acquire respective data, which can be transmitted uphole (e.g., via wireline 110) to a computing device 140a. Thereafter, the pulsed-neutron tool 122 can be positioned in the wellbore 102 for acquiring additional data. For example, a wellbore operator can position the pulsed-neutron tool 122 in the wellbore 102 after the wellbore 102 has been cased and cemented. The pulsed-neutron tool 122 can be operated to acquire additional data, which can be transmitted uphole to the computing device 140. In some examples, the computing device 140a can determine a wettability associated with the wellbore 102 or the subterranean formation 104 based on the data received from the dielectric logging tool 118, the resistivity logging tool 120, the pulsed-neutron tool 122, or any combination of these. In other examples, the computing device 140a can process at least a portion of the data received from the received from the dielectric logging tool 118, the resistivity logging tool 120, the pulsed-neutron tool 122, or any combination of these. The computing device 140a can transmit the processed or unprocessed data to another computing device 140b via a wired or wireless network 146. The other computing device 140b can be offsite, such as at a data-processing center. The other computing device 140b can receive the data and determine a wettability associated with the wellbore 102 based on the data.

The computing devices 140a-b can be positioned belowground, aboveground, onsite, in a vehicle, offsite, etc. The computing devices 140a-b can include a processor interfaced with other hardware via a bus. A memory, which can include any suitable tangible (and non-transitory) computer-readable medium, such as RAM, ROM, EEPROM, or the like, can embody program components that configure operation of the computing devices 140a-b. In some aspects, the computing devices 140a-b can include input/output interface components (e.g., a display, printer, keyboard, touch-sensitive surface, and mouse) and additional storage.

The computing devices 140a-b can include communication devices 144a-b. The communication devices 144a-b can represent one or more of any components that facilitate a network connection. In the example shown in FIG. 1, the communication devices 144a-b are wireless and can include wireless interfaces such as IEEE 802.11, Bluetooth, or radio interfaces for accessing cellular telephone networks (e.g., transceiver/antenna for accessing a CDMA, GSM, UMTS, or other mobile communications network). In some examples, the communication devices 144a-b can use acoustic waves, surface waves, vibrations, optical waves, or induction (e.g., magnetic induction) for engaging in wireless communications. In other examples, the communication devices 144a-b can be wired and can include interfaces such as Ethernet, USB, IEEE 1394, or a fiber optic interface. The computing devices 140a-b can receive wired or wireless communications from one another and perform one or more tasks based on the communications. For example, the computing device 140a can receive data from the dielectric logging tool 118, the resistivity logging tool 120, the pulsed-neutron tool 122, or any combination of these and transmit at least a portion of the data to the other computing device 140b via the network 146. The other computing device 140b can receive the data and determine the wettability associated with the subterranean formation 104 based on the data.

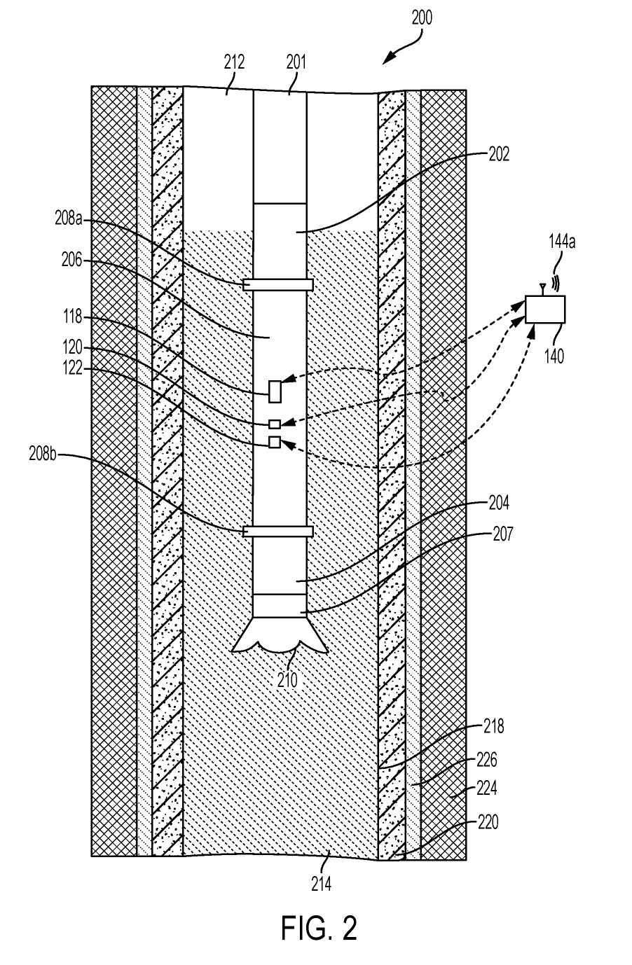

FIG. 2 is a cross-sectional view of an example of part of a well system 200 that includes a system for determining downhole wettability according to some aspects. The well system 200 includes a wellbore 218. The wellbore 218 can be drilled from a subterranean formation. In some examples, the subterranean formation can include an invaded zone 220, an uninvaded zone 224, a transition zone 226, or any combination of these.

In some examples, the wellbore 218 can include a fluid 214 (e.g., mud). The fluid 214 can flow in an annulus 212 positioned between the well tool 201 and a wall of the wellbore 218. In some examples, the fluid 214 can filter into rock or other material of the subterranean formation. This can generate a mud filtrate that penetrates the invaded zone 220.

A well tool 201 (e.g., a logging-while-drilling tool) can be positioned in the wellbore 218. The well tool 201 can include various subsystems 202, 204, 206, 207. For example, the well tool 201 can include a subsystem 202 that includes a communication subsystem. The well tool 201 can also include a subsystem 204 that includes a saver subsystem or a rotary steerable system. A tubular section or an intermediate subsystem 206 (e.g., a mud motor or a measuring-while-drilling module) can be positioned between the other subsystems 202, 204. In some examples, the well tool 201 can include a drill bit 210 for drilling the wellbore. The drill bit 210 can be coupled to another tubular section or intermediate subsystem 207 (e.g., a measuring-while-drilling module or a rotary steerable system). In some examples, the well tool 201 can also include tubular joints 208a, 208b.

In some examples, the well tool 201 can include a dielectric logging tool 118, a resistivity logging tool 120, a pulsed-neutron tool 122, or any combination of these. The dielectric logging tool 118, resistivity logging tool 120, and pulsed-neutron tool 122 can be in wired or wireless communication with a computing device 140. The computing device 140 can receive data from the dielectric logging tool 118, resistivity logging tool 120, pulsed-neutron tool 122, or any combination of these. The computing device 140 can determine, based on the data, a wettability associated with the wellbore 218.

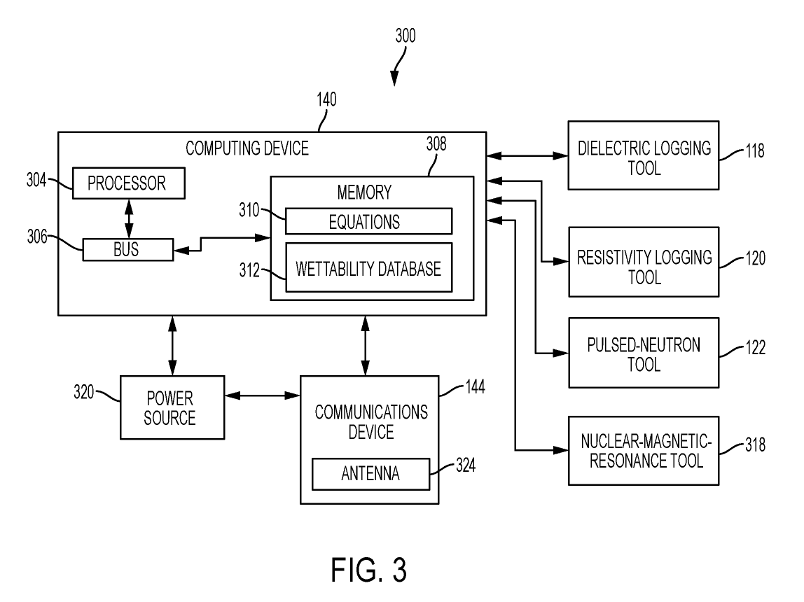

FIG. 3 is a block diagram of an example of a system 300 for determining downhole wettability according to some aspects. In some examples, the components shown in FIG. 3 (e.g., the computing device 140, power source 320, and communications device 144) can be integrated into a single structure. For example, the components can be within a single housing. In other examples, the components shown in FIG. 3 can be distributed (e.g., in separate housings) and in electrical communication with each other.

The system 300 includes a computing device 140. The computing device 140 can include a processor 304, a memory 308, and a bus 306. The processor 304 can execute one or more operations for determining downhole wettability. The processor 304 can execute instructions stored in the memory 308 to perform the operations. The processor 304 can include one processing device or multiple processing devices. Non-limiting examples of the processor 304 include a Field-Programmable Gate Array (“FPGA”), an application-specific integrated circuit (“ASIC”), a microprocessor, etc.

The processor 304 can be communicatively coupled to the memory 308 via the bus 306. The non-volatile memory 308 may include any type of memory device that retains stored information when powered off. Non-limiting examples of the memory 308 include electrically erasable and programmable read-only memory (“EEPROM”), flash memory, or any other type of non-volatile memory. In some examples, at least some of the memory 308 can include a medium from which the processor 304 can read instructions. A computer-readable medium can include electronic, optical, magnetic, or other storage devices capable of providing the processor 304 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

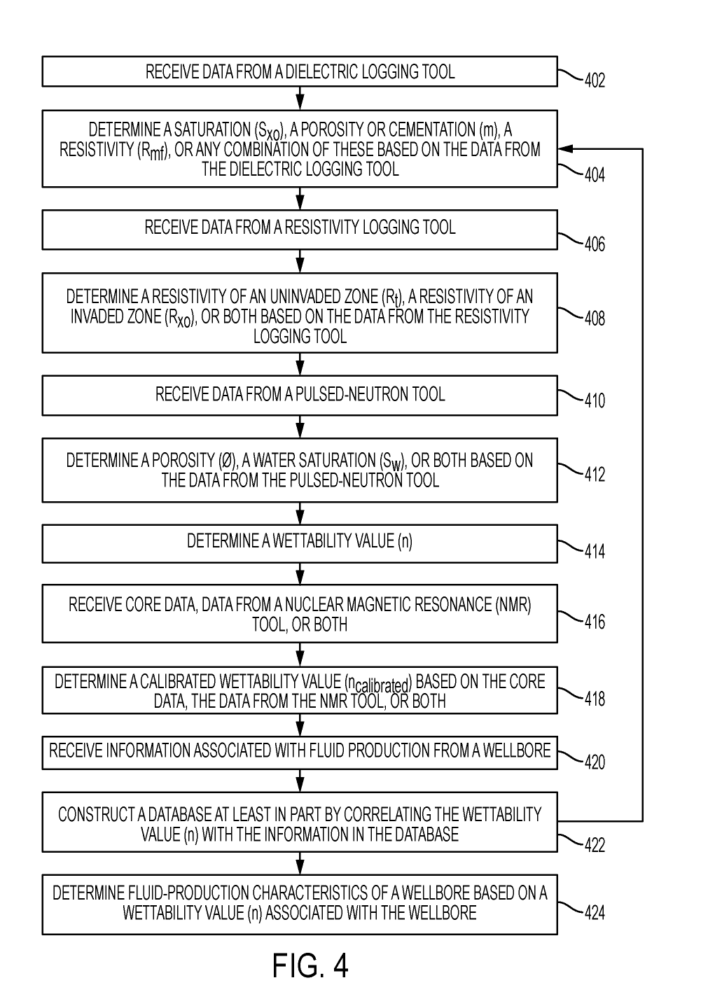

In some examples, the memory 308 can include one or more equations 310. The equations 310 can be usable for determining a wettability associated with a subterranean formation. Examples of the equations 310 can include any of the equations described with respect to FIG. 4. For example, the equations 310 can include one or more of Equations 4.3a-d described with respect to FIG. 4.

In some examples, the memory 308 can include a wettability database 312. The wettability database 312 can include one or more wettability values correlated with fluid-production characteristics of a wellbore. For example, the wettability database 312 can include a particular wettability value (e.g., 3.2) correlated to a particular ratio of oil-to-water (e.g., 3:2 oil-to-water) produced by a wellbore having the particular wettability value. An example of wettability database 312 is described in greater detail with respect to block 422 of FIG. 4.

The system 300 can include a power source 320. The power source 320 can be in electrical communication with the computing device 140 and the communications device 144. In some examples, the power source 320 can include a battery or an electrical cable (e.g., a wireline).

In some examples, the power source 320 can include an AC signal generator. The computing device 140 can operate the power source 320 to apply a transmission signal to the antenna 324. For example, the computing device 140 can cause the power source 320 to apply a voltage with a frequency within a specific frequency range to the antenna 324. This can cause the antenna 324 to generate a wireless transmission. In other examples, the computing device 140, rather than the power source 320, can apply the transmission signal to the antenna 324 for generating the wireless transmission.

The system 300 can include a communications device 144. The communications device 144 can include or can be coupled to an antenna 324. In some examples, part of the communications device 144 can be implemented in software. For example, the communications device 144 can include instructions stored in memory 308.

The communications device 144 can receive signals from remote devices and transmit data to remote devices (e.g., the computing device 140b of FIG. 1). For example, the communications device 144 can transmit wireless communications that are modulated by data via the antenna 324. In some examples, the communications device 144 can receive signals (e.g., associated with data to be transmitted) from the processor 304 and amplify, filter, modulate, frequency shift, and otherwise manipulate the signals. In some examples, the communications device 144 can transmit the manipulated signals to the antenna 324. The antenna 324 can receive the manipulated signals and responsively generate wireless communications that carry the data.

In some examples, the system 300 includes a dielectric logging tool 118. The dielectric logging tool 118 can detect a dielectric constant, a porosity, a saturation, or any of these and transmit data associated with the dielectric constant, porosity, or saturation, respectively, to the computing device 140 (e.g., the processor 304 of the computing device 140). Additionally or alternatively, the system 300 can include a resistivity logging tool 120. The resistivity logging tool 120 can detect a resistivity and transmit data associated with the resistivity to the computing device 140. Additionally or alternatively, the system 300 can include a pulsed-neutron tool 122. The pulsed-neutron tool 122 can detect a porosity, a saturation, or both and transmit data associated with the porosity, saturation, or both to the computing device 140.

In some examples, the system 300 can include other well tools, such as nuclear-magnetic-resonance tool 318. The other well tools can detect other characteristics associated with a wellbore or a subterranean formation and transmit data associated with the other characteristics to the computing device 140. For example, the nuclear-magnetic-resonance tool 318 can detect a type of a fluid present in a wellbore, a quantity of the fluid present in the wellbore, a characteristic of the fluid present in the wellbore, a size of a pore of a solid material containing the fluid in the wellbore, or any combination of these and transmit associated data to the computing device 140.

The computing device 140 can receive the data from the dielectric logging tool 118, the resistivity logging tool 120, the pulsed-neutron tool 122, the nuclear-magnetic-resonance tool 318, other well tools, or any combination of these. In some examples, the computing device 140 can determine a wettability associated with the wellbore based on the data. In other examples, the computing device 140 can transmit the data, or a processed version of the data, to another computing device (e.g., positioned offsite). The computing device 140 can transmit the data to the other computing device via the communications device 144.

FIG. 4 is an example of a flow chart of a process for determining downhole wettability according to some aspects. Some examples can include more, fewer, or different blocks than those shown in FIG. 4. The blocks shown in FIG. 4 can be implemented using, for example, one or more of the computing devices 140a-b shown in FIG. 1.

In block 402, a computing device (e.g., computing device 140 of FIG. 3) receives data from a dielectric logging tool (e.g., dielectric logging tool 118 of FIG. 3). The dielectric logging tool can be positioned on a wireline tool, a drilling tool, or another tool for use in a wellbore. The computing device can receive the data via a wired or wireless interface.

In block 404, the computing device determines a water saturation in an invaded zone of a subterranean formation (Sₓₒ), a porosity or cementation associated with the subterranean formation (m), a resistivity of an invading filtrate (e.g., a mud filtrate) in an invaded zone of the subterranean formation (R_{mf}), or any combination of these based on the data from the dielectric logging tool.

For example, the computing device can determine a water saturation in an invaded zone of a wellbore drilled from a subterranean formation. The water saturation in the invaded zone can be represented by Sₓₒ. For a wellbore that includes a mixture of mud filtrate and hydrocarbons, a value for the water saturation of the invaded zone can be determined based on the following equation:

\sqrt{ε*fm}=(1−Øₜₒₜₐₗ)·\sqrt{ε*ma}+Øₜₒₜₐₗ(1−Sₓ₀)·\sqrt{ε*hc}+Øₜₒₜₐₗ·Sₓ₀·\sqrt{ε*mf}

When rearranged to solve for Sₓₒ, the above equation can be represented as:

$${S}_{xo} = \frac{\sqrt{{ɛ}^{*} fm} - ( 1 - {∅}_{total} ) \cdot \sqrt{{ɛ}_{ma}^{*}} - {∅}_{total} \cdot \sqrt{{ɛ}^{*} hc}}{{∅}_{total} \cdot ( \sqrt{{ɛ}^{*} fm} - \sqrt{{ɛ}^{*} hc} )} \qquad ( Equation 1.1 )$$

where ε*fm can be a dielectric constant associated with the invaded zone of the wellbore; ε*ma can be a matrix complex dielectric-constant associated with the invaded zone of the wellbore; ε*hc can be a hydrocarbon complex dielectric-constant associated with the invaded zone of the wellbore; ε*_{mf} can be a complex dielectric-constant of the mud filtrate in the invaded zone; and Øₜₒₜₐₗ can be a total porosity of the subterranean formation. In some examples, values for some or all of these variables can all be obtained using the dielectric logging tool. For example, the computing device can determine ε*fm, ε*ma, ε*hc, ε*_{mf}, Øₜₒₜₐₗ, or any combination of these based on the data from the dielectric logging tool.

In some examples, the computing device can determine the water saturation in the invaded zone of the subterranean formation (Sₓₒ) based on (e.g., based on a relationship between) the dielectric constant associated with the invaded zone of the wellbore, the matrix complex dielectric-constant associated with the invaded zone of the wellbore, the hydrocarbon complex dielectric-constant associated with the invaded zone of the wellbore, the complex dielectric-constant of the mud filtrate in the invaded zone, the total porosity of the subterranean formation, or any combination of these. For example, the computing device can receive from the dielectric logging tool, or retrieve from memory, values associated with the dielectric constant associated with the invaded zone of the wellbore, the matrix complex dielectric-constant associated with the invaded zone of the wellbore, the hydrocarbon complex dielectric-constant associated with the invaded zone of the wellbore, the complex dielectric-constant of the mud filtrate in the invaded zone, the total porosity of the subterranean formation, or any combination of these. The computing device can determine a first value by calculating the square root of the dielectric constant associated with invaded zone of the wellbore. The computing device can determine a second value by multiplying a square root of the matrix complex dielectric-constant by a result of one minus the total porosity of the subterranean formation. The computing device can determine a third value by multiplying a square root of the hydrocarbon complex dielectric-constant by the total porosity of the subterranean formation. The computing device can subtract the second value and the third value from the first value to determine a dividend. The computing device can determine a fourth value by subtracting a square root of the hydrocarbon complex dielectric-constant associated with the invaded zone of the wellbore from a square root of the complex dielectric-constant of the mud filtrate in the invaded zone. The computing device can determine a divisor by multiplying the fourth value by the total porosity of the subterranean formation. The computing device can determine the water saturation in the invaded zone of the subterranean formation by dividing the dividend by the divisor.

In some examples, ε*ₘₐ can be a complex matrix dielectric-constant for a multi-mineral subterranean formation (e.g., a subterranean formation that includes multiple different minerals). In such an example, \sqrt{ε*ₘₐ} can be the weighted average of the square root of the dielectric constants for the various minerals that make up the multi-mineral formation. The weights can be the relative amounts of the minerals in the multi-mineral formation. In such an example, \sqrt{ε*ₘₐ} can be represented according to the following equation:

$$\sqrt{{ɛ}_{ma}^{*}} = \frac{1}{{\sum }_{i} {V}_{i}} {\sum }_{i} ( {V}_{i} \sqrt{{ɛ}_{i}^{*}} ) \qquad ( Equation 1.2 )$$

where Vᵢ can be the volume of each of the minerals in the multi-mineral formation, and ε*ᵢ can be the complex dielectric-constant corresponding to each of the minerals in the multi-mineral formation.

Some subterranean formations can include boron, pyrite, clay, or any combination of these. Boron, pyrite, and clay can affect the value for the water saturation determined using Equation 1.1. For example, the dielectric constant of pyrite can be large. In one example, at 1 gigahertz (GHz), a real portion of a dielectric constant for pyrite can be 80 and an imaginary portion of the dielectric constant can be 200. In some examples, the computing device can substitute Equation 1.2 into Equation 1.1 to determine a value for the water saturation based on (e.g., that takes into account or corrects for) the effects or presence of boron, pyrite, clay, or any combination of these. This can ultimately lead to a more accurate determination of wettability.

For example, the computing device can determine the water saturation in the invaded zone of the subterranean formation (Sₓₒ) based on a complex matrix dielectric-constant for a multi-mineral subterranean formation. In such an example, for each mineral in the multi-mineral formation, the computing device can determine a value corresponding to a volume of a mineral in the multi-mineral formation multiplied by a square root of a complex-dielectric constant associated with the mineral in the multi-mineral formation. The computing device can add the values together to determine a dividend. The computing device can determine a divisor by aggregating all of the volumes of the minerals in the multi-mineral formation. The computing device can determine the complex matrix dielectric-constant for the multi-mineral subterranean formation by dividing the dividend by the divisor. The computing device can use the complex matrix dielectric-constant to determine the water saturation in the invaded zone of the subterranean formation.

The computing device can additionally or alternatively determine a porosity or cementation associated with the subterranean formation. The porosity or cementation associated with the subterranean formation can be represented by m. A value for m can be determined according to the following equation:

$$m = \frac{log \frac{{ɛ}_{w}}{ɛ}}{\frac{∅ \cdot \frac{ɛ}{{ɛ}_{w}} \cdot ( {ɛ}_{w} - {ɛ}_{ma} )}{ɛ - {ɛ}_{ma}}} \qquad ( Equation 1.3 )$$

where ε can be a real part of a dielectric constant of the subterranean formation measured by the dielectric logging tool; ε_{w} can be a real part of a dielectric constant of water in the uninvaded zone of the subterranean formation as measured by the dielectric logging tool; and εₘₐ can be a real part of a dielectric constant of a rock matrix as measured by the dielectric logging tool. In some examples, the rock matrix can include fine grained, interstitial particles that lie between larger particles or in which larger particles are embedded in sedimentary rocks, such as sandstones and conglomerates. The computing device can determine the porosity or cementation value m based on the ε, the ε_{w}, and the εₘₐ values (e.g., using Equation 1.3).

For example, the computing device can determine a first value by calculating a log of a real part of a dielectric constant of water in the subterranean formation divided by another real part of a dielectric constant of the subterranean formation. The computing device can use this value as a dividend. The computing device can determine a second value by subtracting the real part of the dielectric constant of the rock matrix from the real part of the dielectric constant of water in the subterranean formation. The computing device can determine a third value by dividing the real part of the dielectric constant of the subterranean formation by the real part of the dielectric constant of water in the subterranean formation. The computing device can determine a fourth value by multiplying a porosity associated with the subterranean formation by the second value and the third value. The computing device can determine a fifth value by dividing the fourth value by a result of the real part of the dielectric constant of the subterranean formation minus the real part of a dielectric constant of the rock matrix. The computing device can use the fifth value was a divisor. The computing device can determine the porosity or cementation value by dividing the dividend by the divisor.

In some examples, εₘₐ can be a complex matrix dielectric constant for a multi-mineral subterranean formation. In such an example, εₘₐ can be represented according to the following equation:

$${ɛ}_{ma} = \frac{1}{{\sum }_{i} {V}_{i}} {\sum }_{i} ( {V}_{i} \sqrt{{ɛ}_{i}^{*}} ) \qquad ( Equation 1.4 )$$

In some examples, Equation 1.4 can be substituted into Equation 1.3 to determine the porosity or cementation for a multi-mineral subterranean formation, such as a subterranean formation that includes boron, pyrite, clay, or any combination of these. By substituting Equation 1.4 into Equation 1.3, the computing device can determine a value for the porosity or cementation based on (e.g., that takes into account or corrects for) the effects or presence of boron, pyrite, clay, or any combination of these. This can ultimately lead to a more accurate determination of wettability.

For example, the computing device can determine the porosity or cementation associated with the subterranean formation (m) based on a complex matrix dielectric-constant for a multi-mineral subterranean formation. In such an example, for each mineral in the multi-mineral formation, the computing device can determine a value corresponding to a volume of a mineral in the multi-mineral formation multiplied by a square root of a complex-dielectric constant associated with the mineral in the multi-mineral formation. The computing device can add the values together to determine a dividend. The computing device can determine a divisor by aggregating all of the volumes of the minerals in the multi-mineral formation. The computing device can determine the complex matrix dielectric-constant for the multi-mineral subterranean formation by dividing the dividend by the divisor. The computing device can use the complex matrix dielectric-constant to determine the porosity or cementation associated with the subterranean formation.

The computing device can additionally or alternatively determine a resistivity of an invading filtrate (e.g., a mud filtrate) in an invaded zone of the subterranean formation. The resistivity can be represented by R_{mf}. A value for the resistivity of the invading filtrate can be determined according to the following equation:

$${R}_{mf} = \frac{82}{T + 7} \cdot [ 0.0123 + \frac{3647.5}{{( 1000 \cdot Kppm )}^{0.995}} ]$$

where T can be a temperature of the invading filtrate penetrating the invading zone, and Kppm can be a salinity of water in the invaded zone. In some examples, values for T and Kppm can be obtained using the dielectric logging tool. The computing device can receive data associated with values for T, Kppm, or both from the dielectric logging tool and determine the resistivity of the invading filtrate based on the values for T and Kppm.

For example, the computing device can determine a first value by dividing eighty two by a result of a temperature of the invading filtrate plus seven. The computing device can determine a second value that is 1000 multiplied by the salinity of water in the invaded zone to the 0.995 power. The computing device can determine a third value by dividing 3647.5 by the second value. The computing device can determine the resistivity of the invading filtrate by multiplying the first value by a sum of 0.0123 plus the third value.

In block 406, the computing device receives data from a resistivity logging tool (e.g., resistivity logging tool 120 of FIG. 3). The resistivity logging tool can be positioned on a wireline tool, a drilling tool, or another tool for use in a wellbore. The computing device can receive the data via a wired or wireless interface.

In block 408, the computing device determines a resistivity of an uninvaded zone of the subterranean formation (Rₜ), a resistivity of an invaded zone of the subterranean formation (Rₓₒ), or both based on the data from the resistivity logging tool.

In some examples, the resistivity logging tool can use multi-component induction (MCI) or triaxial induction (e.g., rather than conventional array induction or laterolog logging). Using MCI or triaxial induction may lead to more accurate resistivity detections. For example, MCI or triaxial induction can lead to more accurate resistivity detections in resistivity-anisotropic subterranean formations that include thinly-laminated sand/shale sequences (e.g., thinly-laminated layers of sand and shale) than other methods of resistivity detection.

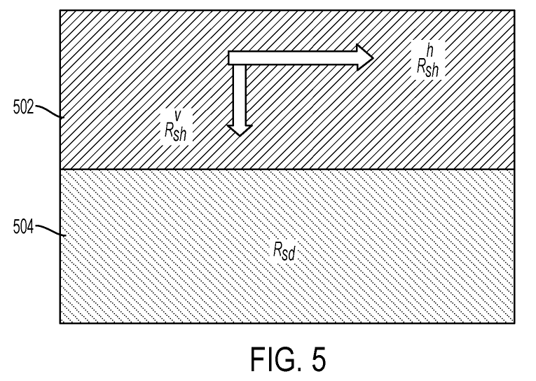

In some examples, an equation for determining the resistivity of the uninvaded zone of the subterranean formation (Rₜ), the resistivity of the invaded zone of the subterranean formation (Rₓₒ), or both can be developed based on a bimodal model, such as the model shown in FIG. 5. In FIG. 5, sand 504 is positioned adjacent to shale 502. The sand 504 can be isotropic sand. For example, a resistivity of the sand 504 can be substantially the same in all directions. The resistivity of the sand 504 can be represented by R_{sd}. The shale 502 can be anisotropic shale. For example, a resistivity of the shale 502 can be directionally dependent. The vertical resistivity of the shale 502 can be represented by Rₛₕ^{v}. The horizontal resistivity of the shale 502 can be represented by Rₛₕ^{h}. Based on the model shown in FIG. 5, the following equation can be developed:

Rᵥ=R_{sd}·(1−Vₗₐₘ)Rₛₕ^{v}·Vₗₐₘ (Equation 2.1)

where Rᵥ can be a vertical resistivity measured by the resistivity logging tool; R_{sd} can be a resistivity of the sand 504 measured by the resistivity logging tool; Rₛₕ^{v} can be a vertical resistivity of the shale 502 measured by the resistivity logging tool; and Vₗₐₘ can be a volumetric fraction of the lamination shale 502. In some examples, Vₗₐₘ can be represented as 1−V_{sd}, where V_{sd} can be a volumetric fraction of the sand 504. Based on the model shown in FIG. 5, another equation can also be developed:

Cₕ=C_{sd}·(1−Vₗₐₘ)+Cₛₕ^{h}·Vₗₐₘ (Equation 2.2)

where Cₕ can be a horizontal conductivity (e.g., calculated by Cₕ=1/Rₕ, where Rₕ can be a horizontal resistivity measured by the resistivity logging tool); C_{sd} can be a conductivity of the sand 504 (e.g., calculated by C_{sd}=1/R_{sd}); and Cₛₕ^{h} can be a horizontal conductivity of the shale 502 (e.g., calculated by Cₛₕ^{h}=1/Rₛₕ^{h}, where Rₛₕ^{h} can be a horizontal resistivity of the shale 502).

Equations 2.1 and 2.2 can be combined and rearranged to solve for R_{sd} and Vₗₐₘ. For example, the computing device can solve for R_{sd} and/or Vₗₐₘ based on the data from the resistivity logging tool. For example, the computing device can determine R_{sd} and/or Vₗₐₘ based on Rᵥ, Rₛᵥ^{h}, Rₕ, Rₛₕ^{h}, or any combination of these. In uninvaded zones, Rₜ can equal R_{sd}. In invaded zones, Rₓₒ can equal R_{sd}. Thus, in some examples, the computing device can determine Rₜ, Rₓₒ, or both based on R_{sd}.

Returning to FIG. 4, in block 410, the computing device receives data from a pulsed-neutron tool (e.g., pulsed-neutron tool 122 of FIG. 3). The pulsed-neutron tool can be positioned on a wireline tool, a drilling tool, or another tool for use in a wellbore. The computing device can receive the data via a wired or wireless interface.

In block 412, the computing device determines a total porosity of the subterranean formation (Øₜₒₜₐₗ), a water saturation of an uninvaded zone of the subterranean formation (S_{w}), or both based on the data from the pulsed-neutron tool.

For example, the computing device can determine a total porosity of a subterranean formation based on the data from the pulsed-neutron tool. The total porosity can be represented as Øₜₒₜₐₗ. The pulsed-neutron tool may be able to determine the total porosity and transmit data associated with the total porosity to the computing device.

The computing device can additionally or alternatively determine a water saturation of an uninvaded zone of the subterranean formation. The water saturation of the uninvaded zone of the subterranean formation can be represented by S_{w}. A value for the water saturation can be determined using the following equation:

$${S}_{w} = \frac{Σ - ( 1 - {∅}_{total} ) \cdot {\sum }_{ma} - {∅}_{total} \cdot {\sum }_{hc}}{{∅}_{total} \cdot ( {\sum }_{w} - {\sum }_{hc} )} \qquad ( Equation 3.1 )$$

where Øₜₒₜₐₗ can be the total porosity of the subterranean formation; and Σₘₐ can be an absorption cross-section for a rock matrix included within the uninvaded zone of the subterranean formation, Σ_{hc} can be an absorption cross-section for hydrocarbon(s) within pores of the rock matrix in the uninvaded zone of the subterranean formation, and Σ_{w} can be an absorption cross-section of water within pores of the rock matrix in the uninvaded zone of the subterranean formation. In some examples, Σₘₐ, Σ_{hc}, and Σ_{w} can be known or derived from core samples or data transmitted by the pulsed-neutron tool. For example, the computing device can determine Σₘₐ, Σ_{hc}, and Σ_{w} using data stored in memory and derived from core samples. As another example, the computing device can receive values for Σₘₐ, Σ_{hc}, and Σ_{w} from the pulsed-neutron tool. The computing device can also determine Øₜₒₜₐₗ based on data from the pulsed-neutron tool. The computing device can determine the water saturation of the uninvaded zone of the subterranean formation (S_{w}) based on the determined values for Øₜₒₜₐₗ, Σₘₐ, Σ_{hc}, and Σ_{w}.

In some examples, Σₘₐ can be a complex matrix for a multi-mineral subterranean formation. In such an example, Σₘₐ can be represented according to the following equation:

$${\sum }_{ma} = \frac{1}{{\sum }_{i} {V}_{i}} {\sum }_{i} ( {V}_{i} {\sum }_{ma}^{i} ) \qquad ( Equation 3.2 )$$

where i can represent a particular rock matrix of multiple rock matrixes that make up the subterranean formation, and Σₘₐⁱ can be an absorption cross-section for the i-th rock matrix.

In some examples, Equation 3.2 can be substituted into Equation 3.1 to determine the water saturation in a multi-mineral subterranean formation, such as a subterranean formation that includes boron, pyrite, clay, or any combination of these. By substituting Equation 3.2 into Equation 3.1, the computing device can determine a value for the water saturation based on (e.g., that takes into account or corrects for) the effects or presence of boron, pyrite, clay, or any combination of these.

For example, the computing device can determine the water saturation of the uninvaded zone of the subterranean formation based on a complex matrix for a multi-mineral subterranean formation. In such an example, for each mineral in the multi-mineral formation, the computing device can determine a resulting value of a volume of the mineral in the multi-mineral formation multiplied by an aggregate sum of the absorption cross-sections of the minerals in the multi-mineral formation. The computing device can add all of the resulting values together to determine a dividend. The computing device can determine a divisor by aggregating all of the volumes of the minerals in the multi-mineral formation. The computing device can determine the complex matrix for the multi-mineral subterranean formation by dividing the dividend by the divisor. The computing device can use the determined complex matrix for Σₘₐ in Equation 3.1 to determine the water saturation of the uninvaded zone of the subterranean formation.

In some examples, Equation 3.1 may yield an inaccurate result for the water saturation if a salinity of the water in the uninvaded zone of the subterranean formation is less than 100,000 parts-per-meter (ppm) and if a porosity of the subterranean formation is below 15%. This can occur, for example, if the water is freshwater and the subterranean formation includes sandstone or limestone. In such an example, the computing device can use the following equation to determine the water saturation:

$${S}_{w} = 1 - A \cdot \frac{( 1 - B \cdot {∅}_{pn} ) \cdot {Y}_{co}}{{∅}_{pn} \cdot ( {ρ}_{hc} - C - {Y}_{co} )}$$

where A, B, and C can be constants based on the pulsed-neutron tool used, a characteristic of the subterranean formation, or both; ρ_{hc} can be a density of a hydrocarbon in the subterranean formation; Y_{co} can be a ratio of carbon to oxygen in the hydrocarbon (e.g., as obtained from the pulsed-neutron tool); and Øₚₙ can be a pulsed-neutron porosity. In some examples, values for Y_{co}, Øₚₙ, or both can be determined based on data from the pulsed-neutron tool. For example, the pulsed-neutron tool can determine values for Y_{co}, Øₚₙ, or both and transmit the value(s) to the computing device. In some examples, ρ_{hc} can be determined based on data from other well tools or resources. For example, a well tool can detect the density of a hydrocarbon in the subterranean formation and transmit associated data to the computing device. In some examples, the computing device can retrieve a value for A, B, C, or any combination of these from memory. The computing device can determine the water saturation of the uninvaded zone of the subterranean formation based on the values for A, B, C, Øₚₙ, Y_{co}, ρ_{hc}, or any combination of these.

In block 414, the computing device determines a wettability value (n). The computing device can determine the wettability value based on the data from the dielectric logging tool, the resistivity logging tool, the pulsed-neutron tool, or any combination of these.

For example, the wettability value can be determined based on Archie's Equation. A version of Archie's equation usable for determining the wettability value associated with an uninvaded zone of the subterranean formation can be:

$${S}_{w} = {( \frac{a}{{∅}^{m}} \cdot \frac{{R}_{w}}{{R}_{t}} )}^{\frac{1}{n}} = {( F \cdot \frac{{R}_{w}}{{R}_{t}} )}^{\frac{1}{n}} \qquad ( Equation 4.1 )$$

where S_{w} can be a water saturation of an uninvaded zone of the subterranean formation; a can be a tortuosity or Archie lithology factor; Ø can be a total porosity of the subterranean formation; m can be a porosity or cementation associated with the subterranean formation; R_{w} can be a resistivity of water in an uninvaded zone of the subterranean formation; Rₜ can be a resistivity of an uninvaded zone of the subterranean formation; and F can be a subterranean-formation resistivity factor.

A version of Archie's equation usable for determining the wettability value associated with an invaded zone of the subterranean formation can be:

$${S}_{xo} = {( \frac{a}{{∅}^{m}} \cdot \frac{{R}_{mf}}{{R}_{xo}} )}^{\frac{1}{n}} \qquad ( Equation 4.2 )$$

where Sₓₒ, can be a water saturation in an invaded zone of a subterranean formation; a can be a tortuosity or Archie lithology factor; Ø can be a total porosity of the subterranean formation; m can be a porosity or cementation associated with the subterranean formation; R_{mf} can be a resistivity of an invading filtrate in an invaded zone of the subterranean formation; and Rₓₒ can be a resistivity of the invaded zone of the subterranean formation.

Four equations for determining the wettability value can be developed from Equations 4.1 and 4.2. The first equation can be:

$$n = \frac{log ( \frac{{R}_{w}}{{R}_{t}} ) - log ( \frac{{R}_{mf}}{{R}_{xo}} )}{log ( \frac{{s}_{w}}{{s}_{xo}} )} \qquad ( Equation 4.3 a )$$

In Equation 4.3a, the wettability value can be determined based on R_{w}, Rₜ, R_{mf}, Rₓₒ, S_{w}, and Sₓₒ. In some examples, the computing device can determine values for R_{w}, Rₜ, R_{mf}, Rₓₒ, S_{w}, and Sₓₒ. In one example, the computing device can retrieve values for R_{w}, Rₜ, R_{mf}, Rₓₒ, S_{w}, and Sₓₒ, or any combination of these from memory. The computing device can determine the wettability value based on (e.g., based on a relationship between) the values for R_{w}, Rₜ, R_{mf}, Rₓₒ, S_{w}, and Sₓₒ.

The second equation can be:

$$n = \frac{log ( \frac{{R}_{w}}{{R}_{t}} ) - m \cdot log ( {∅}_{total} )}{log ( {s}_{w} )} \qquad ( Equation 4.3 b )$$

In Equation 4.3b, the wettability value can be determined based on R_{w}, Rₜ, m, Øₜₒₜₐₗ, and S_{w}. In some examples, the computing device can determine values for R_{w}, Rₜ, m, Øₜₒₜₐₗ, and S_{w}. In one example, the computing device can retrieve values for R_{w}, Rₜ, m, Øₜₒₜₐₗ, and S_{w}, or any combination of these from memory. The computing device can determine the wettability value based on the values for R_{w}, Rₜ, m, Øₜₒₜₐₗ, and S_{w}.

The third equation can be:

$$n = \frac{log ( \frac{{R}_{mf}}{{R}_{xo}} ) - m \cdot log ( {∅}_{total} )}{log ( {s}_{xo} )} \qquad ( Equation 4.3 c )$$

In Equation 4.3c, the wettability value can be determined based on R_{mf}, Rₓₒ, m, Øₜₒₜₐₗ, and Sₓₒ. In some examples, the computing device can determine values for R_{mf}, Rₓₒ, m, Øₜₒₜₐₗ, and Sₓₒ. In one example, the computing device can retrieve values for R_{mf}, Rₓₒ, m, Øₜₒₜₐₗ, Sₓₒ, or any combination of these from memory. The computing device can determine the wettability value based on the values for R_{mf}, Rₓₒ, m, Øₜₒₜₐₗ, and Sₓₒ.

The fourth equation can be:

$$n = \frac{log ( \frac{{R}_{o}^{′}}{{R}_{xo}} )}{log ( {s}_{xo} )} \qquad ( Equation 4.3 d )$$

where R′ₒ can be a resistivity of a 100% invading-filtrate bearing subterranean-formation. The 100% invading-filtrate bearing subterranean-formation can include a subterranean formation in which a pore space of the subterranean formation is filled with 100% invading filtrate. In some examples, a value for R′ₒ can be determined via the resistivity logging tool (e.g., using multi-array induction) or a laterolog. For example, the resistivity logging tool can detect the resistivity of the 100% invading-filtrate bearing subterranean-formation and transmit associated data to the computing device. In Equation 4.3d, the wettability value can be determined based on R′ₒ, Rₓₒ, and Sₓₒ. In some examples, the computing device can determine values for R′ₒ, Rₓₒ, and Sₓₒ. In one example, the computing device can retrieve values for R′ₒ Rₓₒ, and Sₓₒ, or any combination of these from memory. The computing device can determine the wettability value based on the values for R′ₒ, Rₓₒ, and Sₓₒ.

In some examples, the computing device can select one or more of Equations 4.3a-d to use to determine the wettability value based on the data available. For example, the computing device can select Equation 4.3a or Equation 4.3d if the computing device has not received data from a pulsed-neutron tool. This is because the computing device may be unable to determine values for Øₜₒₜₐₗ and S_{w} without data from the pulsed-neutron tool, which may be necessary to calculate n using Equations 4.3b-c. The computing device can determine the wettability value by inserting known or calculated values (e.g., as determined in blocks 402-412) into a selected equation.

In some examples, the computing device can determine a wettability value (n) using two or more of Equations 4.3a-d. The computing device can average the determined wettability values to generate an averaged wettability value. The computing device can use the averaged wettability value as the wettability value.

In some examples, the wettability value can be a number between 0 and 10, where 0 can represent a strongly water-wet material and 10 can represent a strongly oil-wet material. A wettability value of 5 can represent a neutral-wet material. The wettability value can be indicative of the wettability of the subterranean formation.

In block 416, the computing device receives core data, data from a nuclear-magnetic-resonance tool, or both. For example, a well operator can take one or more core samples from the subterranean formation and analyze the core samples. In some examples, the computing device can receive the core data from the well operator via an input device. The core data can include one or more characteristics associated with a core sample. Additionally or alternatively, an analysis device (e.g., a computing device used for analyzing a core sample) can automatically transmit core data to the computing device. The computing device can receive the core data from the well operator or the analysis device.

In some examples, the computing device can receive data from a nuclear-magnetic-resonance tool. For example, the well operator can cause the nuclear-magnetic-resonance tool to be positioned in the wellbore. The nuclear-magnetic-resonance tool can determine one or more properties of the wellbore and transmit data associated with the one or more properties uphole to the computing device. Examples of a property of the wellbore can include a type of a fluid present in the wellbore, a quantity of the fluid present in the wellbore, a characteristic of the fluid present in the wellbore, and a size of a pore of a solid material containing the fluid in the wellbore.

In block 418, the computing device determines a calibrated wettability value (n_{calibrated}) based on the core data, the data from the nuclear-magnetic-resonance tool, or both. For example, the computing device can use the following equation to determine the calibrated wettability value:

n_{calibrated}=C₁·n+C₂

where C₁ and C₂ can be constants determined based on the core data, the data from the nuclear-magnetic-resonance tool, or both. For example, the computing device can retrieve a value for C₁, C₂, n, or any combination of these from memory. The computing device can determine the calibrated wettability value based on the values for C₁, C₂, n, or any combination of these. The computing device can use the calibrated wettability value as the wettability value (n).

In block 420, the computing device receives information associated with fluid production from a wellbore (e.g., drilled from the subterranean formation for which the wettability value was determined). For example, the computing device can receive information associated with an amount of oil, water, gas, or other fluid produced from the wellbore over a predetermined period of time. In some examples, the computing device can receive the information from a well operator via an input device. Additionally or alternatively, the computing device can receive sensor data from one or more sensors positioned within, or proximate to, the wellbore. Examples of the sensors can include fluid-flow sensors, fluid-viscosity sensors, fiber optic sensors, temperature sensors, pressure sensors, or any combination of these. The computing device can determine the information associated with fluid production based on the sensor data.

In block 422, the computing device constructs a database at least in part by correlating the wettability value (n) with the information associated with the fluid production in the database. For example, the computing device can generate a lookup table in which wettability values are correlated with ratios of two or more fluids produced from a well system. In one example, the wettability value can be 1.3, and the information associated with the fluid production can include a ratio of oil-to-water that is 3:2. The computing device can correlate the wettability value 1.3 to the ratio of oil-to-water 3:2 in the database.

In some examples, the computing device can return to block 402 and repeat blocks 402-422 to construct a database that includes multiple wettability values (n) correlated to multiple hydrocarbon-production characteristics.

In block 424, the computing device determines one or more fluid-production characteristics associated with a wellbore based on a wettability value (n) associated with the wellbore. For example, the computing device can determine a wettability value for another wellbore with unknown hydrocarbon-production characteristics. The computing device can then consult the database (e.g., discussed in block 422) to determine one or more hydrocarbon-production characteristics associated with the determined wettability value. The computing device can output the determined hydrocarbon-production characteristics (e.g., via a display or printer) to the well operator. The hydrocarbon-production characteristics can provide valuable information about the wellbore, for example, prior to beginning hydrocarbon production. Some examples can allow for a well operator to determine a wettability of a wellbore, a fluid-production characteristic of the wellbore, or both without using core sampling or a nuclear-magnetic-resonance tool, which may be expensive, unavailable, or impractical.

In some aspects, systems, devices, and methods for determining downhole wettability are provided according to one or more of the following examples:

### Example #1

A system can include a dielectric logging tool positionable in a wellbore formed through a subterranean formation. The system can include a resistivity logging tool positionable in the wellbore. The system can include a computing device in communication with the dielectric logging tool and the resistivity logging tool for receiving a first data set from the dielectric logging tool and a second data set from the resistivity logging tool and determining a wettability associated with the subterranean formation based on the first data set and the second data set.

### Example #2

The system of Example #1 may feature the computing device being for determining the wettability associated with the subterranean formation based on an effect of clay, pyrite, boron, and/or a lamination in the subterranean formation.

### Example #3

The system of any of Examples #1-2 may feature the first data set including a water saturation of an invaded zone of the subterranean formation, a porosity associated with the subterranean formation, a first resistivity of an invading filtrate in the invaded zone of the subterranean formation, or any combination of these. The second data set can include a second resistivity of an uninvaded zone of the subterranean formation, a third resistivity of the invaded zone of the subterranean formation, or both of these.

### Example #4

The system of any of Examples #1-3 may feature a pulsed-neutron tool. The computing device can be further in communication with the pulsed-neutron tool for receiving a third data set associated with the subterranean formation from the pulsed-neutron tool and determining the wettability based on the third data set.

### Example #5

The system of Example #4 may feature the third data set including a total porosity of the subterranean formation, a water saturation of an invaded zone of the subterranean formation, or both of these.

### Example #6

The system of any of Examples #1-5 may feature a nuclear-magnetic-resonance tool. The computing device can further be in communication with the nuclear-magnetic-resonance tool for receiving another data set associated with the subterranean formation from the nuclear-magnetic-resonance tool and determining the wettability based on the data set.

### Example #7

A computing device can include a processing device and a memory device in which instructions executable by the processing device are stored. The instructions can be for causing the processing device to receive a first data set from a dielectric logging tool positionable in a wellbore formed through a subterranean formation; receive a second data set from a resistivity logging tool positionable in the wellbore; determine a wettability associated with the wellbore based on the first data set and the second data set; or any combination of these.

### Example #8

The computing device of Example #7 may feature the memory device further including instructions executable by the processing device for causing the processing device to determine the wettability associated with the wellbore based on an effect of clay, pyrite, boron, or a lamination in the wellbore.

### Example #9

The computing device of any of Examples #7-8 may feature the first data set including a water saturation of an invaded zone of the subterranean formation, a porosity associated with the subterranean formation, a first resistivity of an invading filtrate in the invaded zone of the subterranean formation, or any combination of these. The second data set can include a second resistivity of an uninvaded zone of the subterranean formation, a third resistivity of the invaded zone of the subterranean formation, or both of these.

### Example #10

The computing device of any of Examples #7-9 may feature the memory device further including instructions executable by the processing device for causing the processing device to: receive a third data set from a pulsed-neutron tool, and determine the wettability based on the third data set.

### Example #11

The computing device of any of Examples #7-10 may feature the memory device further including instructions executable by the processing device for causing the processing device to: receive information associated with hydrocarbon production from the wellbore, and correlate the wettability to the information associated with hydrocarbon production in a database.

### Example #12

The computing device of any of Examples #7-11 may feature the memory device further including instructions executable by the processing device for causing the processing device to: determine a wettability value associated with another wellbore; access a database comprising wettability values correlated to hydrocarbon-production information; determine, using the database and based on the wettability value, particular hydrocarbon-production information associated with the other wellbore; or any combination of these.

### Example #13

The computing device of any of Examples #7-12 may feature the memory device further including instructions executable by the processing device for causing the processing device to: receive another data set associated with a core sample from the wellbore and/or still another data set from a nuclear-magnetic-resonance tool, and determine the wettability based on the data set(s).

### Example #14

A method can include receiving a first data set from a dielectric logging tool positioned in a wellbore formed through a subterranean formation. The method can include receiving a second data set from a resistivity logging tool positioned in the wellbore. The method can include determining a wettability associated with the subterranean formation based on the first data set and the second data set.

### Example #15

The method of Example #14 may feature determining the wettability associated with the subterranean formation based on an effect of clay, pyrite, boron, and/or a lamination in the subterranean formation.

### Example #16

The method of any of Examples #14-15 may feature receiving a water saturation of an invaded zone of the subterranean formation, a porosity associated with the subterranean formation, a first resistivity of an invading filtrate in the invaded zone of the subterranean formation, or any combination of these from the dielectric logging tool. The method may feature receiving a second resistivity of an uninvaded zone of the subterranean formation, a third resistivity of the invaded zone of the subterranean formation, or both of these from the resistivity logging tool.

### Example #17

The method of any of Examples #14-16 may feature receiving a third data set associated from a pulsed-neutron tool, and determining the wettability based on the third data set.

### Example #18

The method of any of Examples #14-17 may feature receiving information associated with hydrocarbon production from the wellbore formed through the subterranean formation. The method may feature correlating the wettability to the information associated with hydrocarbon production in a database.

### Example #19

The method of any of Examples #14-18 may feature determining a wettability value associated with another wellbore. The method may feature accessing a database comprising wettability values correlated to hydrocarbon-production information. The method may feature determining, using the database and based on the wettability value, particular hydrocarbon-production information associated with the other wellbore.

### Example #20

The method of any of Examples #14-19 may feature receiving another data set associated with a core sample from the subterranean formation and/or still another data set from a nuclear-magnetic-resonance tool. The method may feature determining the wettability based on the data set(s).

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a dielectric logging tool positionable in a wellbore formed through a subterranean formation;
a resistivity logging tool positionable in the wellbore; and
a computing device in communication with the dielectric logging tool and the resistivity logging tool for receiving a first data set from the dielectric logging tool and a second data set from the resistivity logging tool and determining a wettability associated with the subterranean formation based on the first data set and the second data set.

2. The system of claim 1, wherein the computing device is for determining the wettability associated with the subterranean formation based on an effect of clay, pyrite, boron, or a lamination in the subterranean formation.

3. The system of claim 2, wherein the first data set comprises a water saturation of an invaded zone of the subterranean formation, a porosity associated with the subterranean formation, and a first resistivity of an invading filtrate in the invaded zone of the subterranean formation, and wherein the second data set comprises a second resistivity of an uninvaded zone of the subterranean formation and a third resistivity of the invaded zone of the subterranean formation.

4. The system of claim 1, further comprising a pulsed-neutron tool, wherein the computing device is further in communication with the pulsed-neutron tool for receiving a third data set associated with the subterranean formation from the pulsed-neutron tool and determining the wettability based on the third data set.

5. The system of claim 4, wherein the third data set comprises a total porosity of the subterranean formation and a water saturation of an invaded zone of the subterranean formation.

6. The system of claim 1, further comprising a nuclear-magnetic-resonance tool, wherein the computing device is further in communication with the nuclear-magnetic-resonance tool for receiving a third data set associated with the subterranean formation from the nuclear-magnetic-resonance tool and determining the wettability based on the third data set.

7. A computing device comprising:
a processing device;
a memory device in which instructions executable by the processing device are stored for causing the processing device to:
receive a first data set from a dielectric logging tool positionable in a wellbore formed through a subterranean formation;
receive a second data set from a resistivity logging tool positionable in the wellbore; and
determine a wettability associated with the wellbore based on the first data set and the second data set.

8. The computing device of claim 7, wherein the memory device further includes instructions executable by the processing device for causing the processing device to:
determine the wettability associated with the wellbore based on an effect of clay, pyrite, boron, or a lamination in the wellbore.

9. The computing device of claim 8, wherein the first data set comprises a water saturation of an invaded zone of the subterranean formation, a porosity associated with the subterranean formation, and a first resistivity of an invading filtrate in the invaded zone of the subterranean formation, and wherein the second data set comprises a second resistivity of an uninvaded zone of the subterranean formation; and a third resistivity of the invaded zone of the subterranean formation.

10. The computing device of claim 7, wherein the memory device further includes instructions executable by the processing device for causing the processing device to:
receive a third data set from a pulsed-neutron tool; and
determine the wettability based on the third data set.

11. The computing device of claim 7, wherein the memory device further includes instructions executable by the processing device for causing the processing device to:
receive information associated with hydrocarbon production from the wellbore; and
correlate the wettability to the information associated with hydrocarbon production in a database.

12. The computing device of claim 7, wherein the memory device further includes instructions executable by the processing device for causing the processing device to:
determine a wettability value associated with another wellbore;
access a database comprising wettability values correlated to hydrocarbon-production information; and
determine, using the database and based on the wettability value, particular hydrocarbon-production information associated with the other wellbore.

13. The computing device of claim 7, wherein the memory device further includes instructions executable by the processing device for causing the processing device to:
receive a third data set associated with a core sample from the wellbore or a fourth data set from a nuclear-magnetic-resonance tool; and
determine the wettability based on the third data set or the fourth data set.

14. A method comprising:
receiving a first data set from a dielectric logging tool positioned in a wellbore formed through a subterranean formation;
receiving a second data set from a resistivity logging tool positioned in the wellbore; and
determining a wettability associated with the subterranean formation based on the first data set and the second data set.

15. The method of claim 14, further comprising:
determining the wettability associated with the subterranean formation based on an effect of clay, pyrite, boron, or a lamination in the subterranean formation.

16. The method of claim 15, further comprising:
receiving a water saturation of an invaded zone of the subterranean formation, a porosity associated with the subterranean formation, and a first resistivity of an invading filtrate in the invaded zone of the subterranean formation from the dielectric logging tool; and
receiving a second resistivity of an uninvaded zone of the subterranean formation and a third resistivity of the invaded zone of the subterranean formation from the resistivity logging tool.

17. The method of claim 16, further comprising:
receiving a third data set associated from a pulsed-neutron tool; and
determining the wettability based on the third data set.

18. The method of claim 14, further comprising:
receiving information associated with hydrocarbon production from the wellbore formed through the subterranean formation; and
correlating the wettability to the information associated with hydrocarbon production in a database.

19. The method of claim 14, further comprising:
determining a wettability value associated with another wellbore;
accessing a database comprising wettability values correlated to hydrocarbon-production information; and
determining, using the database and based on the wettability value, particular hydrocarbon-production information associated with the other wellbore.

20. The method of claim 14, further comprising:
receiving a third data set associated with a core sample from the subterranean formation or a fourth data set from a nuclear-magnetic-resonance tool; and
determining the wettability based on the third data set or the fourth data set.
